(19) United States
(12) Patent Application Publication
(10) Pub. No.: US 2005/0096959 A1
(43) Pub. Date: May 5, 2005

(54) Rule engine method and system

(75) Inventors: Anush Kumar, Seattle, WA (US); Jin Li, Sammamish, WA (US); Todd L. Paul, Snohomish, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/699,419

(22) Filed: Oct. 31, 2003

(51) Int. Cl. G06F 17/60

(52) U.S. Cl. 705/8

(57) ABSTRACT

Providing tracking of operations in an automated business process includes executing a workflow that includes business operations defined at nodes in the business process. The business rules are applied to the workflow at the nodes such that the operations are affected by the rule content. The business rules can be optionally changed and subsequently, the changed business rules can be applied to the workflow during execution without stopping execution of the workflow. A correlation mechanism is provided between the business rules applied to the operations nodes and the corresponding affected operations. The workflow and rule engine processors are integrated providing correlation and tracking of the workflow progress. A declarative method of expressing changes to the business rules is included. An optional query function to retrieve information relative to the operation being performed enhances performance of the workflow.

### FIELD OF THE INVENTION

The invention relates generally to the field of business process automation and more specifically to the field of automated workflow processing in conjunction with a rules engine.

### BACKGROUND OF THE INVENTION

Business procedures vary according to the type of business and the type of process involved. For example, a bank business procedure in processing a loan is different than the same bank's procedure in ordering stationery supplies. Naturally, procedures vary widely across industries as well. A bank's set of procedures are likely to differ from that of an automobile dealership who also has the requirements to process loans and buy stationery. Prior art systems for accommodating such variations in business procedures have typically employed the use of two separate systems to model and execute the business or workflow process and the policies or business rules. The execution of a workflow process may occur within a business procedures processor and the execution of the business rules may occur within a rules engine.

The business procedures processor may be a processor that executes a procedure that outlines, for example, a workflow for a document that requires processing. Since the basic flow of a document through a business process may be fixed, for example, moving from department to department, the basic outline of the workflow of the business process is somewhat constant. The larger variable may be the business rules that are used as decision criteria for moving from one part of a workflow process to another part of a workflow process. For example, interest rates on loans processed via a bank may vary often. Reprogramming a workflow in a business processor is not as efficient as merely reprogramming a rule engine which supplies decision criteria to the workflow. The advantage to this prior art approach has been that a standardized workflow of the business procedure may remain a constant whereas the rules engine which stores the ever-changing business rules may be reprogrammed as required. This dual-engine approach has been widely adopted as a standard for implementing automated business processes. However, as will be described below, there are drawbacks to the prior art approach of having a dual engine system.

FIG. 2 depicts a prior art system 200 for business process automation. Typically, a procedure for a business process, such as a procurement process, is programmed as a series of steps to be run on a business procedure processor 210. This business procedure processor implements the business process workflow. The workflow is implemented via the use of desirable business process steps 220 to points in the business workflow where a transaction may occur. The business process resident in the business procedure processor is governed by the implemented business steps requiring the use of a rules engine 230 to assist the flow of the process at decision points in the workflow. If a business process requires that an authorization for a procurement be checked, the business procedure processor 210 may request the appropriate rule from the rules engine 230. For example, the business rule, such as “authorization not required if the procurement amount is under $100.00”, if interfaced with the business procedure processor, would provide knowledge of the rule for authorization and provide the needed criteria for the business procedure processor 210 to continue processing the workflow.

The above-stated advantage of having a rules engine-based storage of the business rules precludes the business procedure processor itself from being modified each time that there is a business rule change. That is, it has been generally easier to reprogram the rules engine 230 than to reprogram the business procedures processor 210. Typically, a programming interface 240 may be used to reprogram the business rules for use by the rules engine 230. One disadvantage of the integration of a business procedure processor 210 with a rules engine 230 is that a custom interface 250 needs to be developed in order to establish a compatibility between the business procedure processor 210 and the rules engine 230. This requires specialized customizing skills as well as time and money resources.

Typically, a prior art system for implementing a business process suffers from poor correlation between the business rules and the operation being performed. Such poor correlation may be exhibited by the lack of in-depth knowledge of why a process failed, terminated prematurely, or was completed with respect to the business rules used. Often, tracking between the business rules and the operation of the business procedure processor is absent or minimal. Another disadvantage in having a separate business procedures processor and rules engine is that at least the business procedure processor itself must be halted or the business process suspended while new rules engine business rules are applied to the business procedure processor. The application of new or modified business rules in the rules engine 230 often requires the procedure processor 210 be brought down to incorporate the change, followed by re-compiling, re-testing, and re-deploying of the process flow for the new rules to become effective. This action wastes time and resources in implementing an automated business procedure. Still another disadvantage is that a skilled programmer may be required to make changes to the business rules resident in the business rules engine. Often, the lead time between the time when an executive desires a business rule change and the time a programmer has completed the change in the system is such that the entire process is unresponsive to external conditions such as market changes.

Thus, there is a need for a business process automation system that can overcome the aforementioned disadvantages including the lack of correlation, the need for a custom software interface between a rule engine and a business procedure processor, the suspension of a business procedure while a business rule change is reprogrammed into a prior art system, and the need for skilled programming of new business rules. The invention addresses the aforementioned needs and solves them with various systems, methods and techniques that enable a more efficient implementation of an automated business process.

### SUMMARY OF THE INVENTION

An exemplary method of providing tracking of operations in an automated business process includes executing a workflow as part of an automated business process. The workflow includes business operations defined at nodes in the business process. The business rules are applied to the workflow at the nodes such that the business operations are affected. The business rules can be optionally changed, and the changed business rules can be subsequently applied to the workflow during execution of the workflow without stopping execution of the workflow. Aspects of the invention additionally provide a correlation mechanism between the business rules applied to the operations nodes and the corresponding affected operations. Thus, unified tracking of the operations within the workflow with respect to the rule execution on the workflow may be provided. This may be useful to track the history of a business item, such as a document, through the workflow process.

Another exemplary method includes utilizing an integrated workflow processor and rules engine to execute a workflow where rule changes can be made using a business rule language. The rule changes may be implemented without preventing execution of the workflow process. Operations in the form of optimized delayed queries over large data sets may be utilized to examine and use only pertinent and required data from large data sets for rule evaluation.

According to another embodiment of the present invention, a workflow processor and a rules engine are integrated to accommodate the production of correlation data between the operation performed and the rule used to execute the workflow operation. XML formatted messages can be used to accommodate passage of a business item though a workflow process. In another embodiment of the invention, a human-readable declarative business rule language expressed in terms of “if, then” statements can be used to define and input new rules based on meta definitions of the desired new rules.

A computer system having at least one processor for the integrated workflow processor and rules engine is presented. The computer system implements exemplary methods of the present invention, such as a method of changing a business rule and implementing the changed rule while the workflow process is executing. The computer system utilizes network connections to facilitate the transfer of business items, such as documents, from one operation to the next according to a workflow. A correlation between an applied rule and a workflow operation is provided.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 illustrates a conventional system implementing a conventional automated business process; and

FIG. 3 illustrates an exemplary embodiment of a system having aspects of the invention.

### DETAILED DESCRIPTION OF ILLUSTRATIVE EMBODIMENTS

Overview

The invention provides for the combination of a workflow processor and a rules engine in the implementation of an automated business process. In one embodiment, the combination of the two machines into a single coherent process provides distinct correlation and a unified tracking mechanism between each business operation executed by the workflow processor and a corresponding business rule executed by the business rules engine. This integration allows a detailed tracking of a document moving through a business process. Another embodiment of the current invention may be implemented such that any change to a business rule may be made and applied to the rules engine and workflow processor components while those components are running. This embodiment relieves the user of the need to stop or suspend the workflow process, recompile, or reboot the automated business process when new business rules are desired to be added to govern the workflow process. Another embodiment of the invention includes a delayed query execution mechanism where database queries may be constructed and executed during execution of the workflow process to further the efficiency of the workflow, in order to only use the relevant data from large data-sets that are pertinent to rule evaluation over the workflow state.

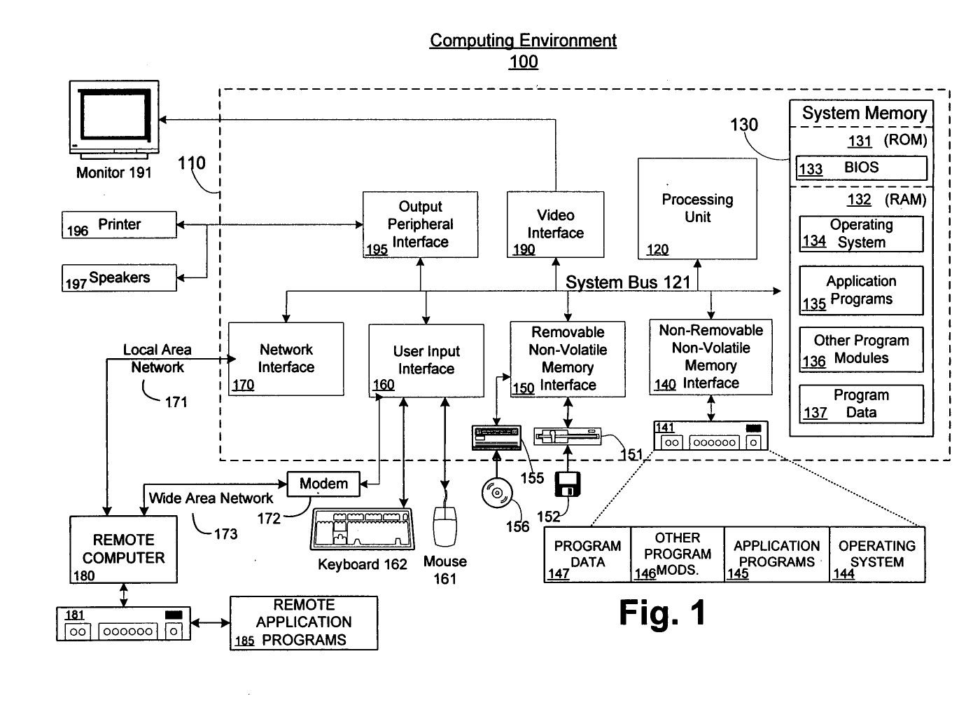

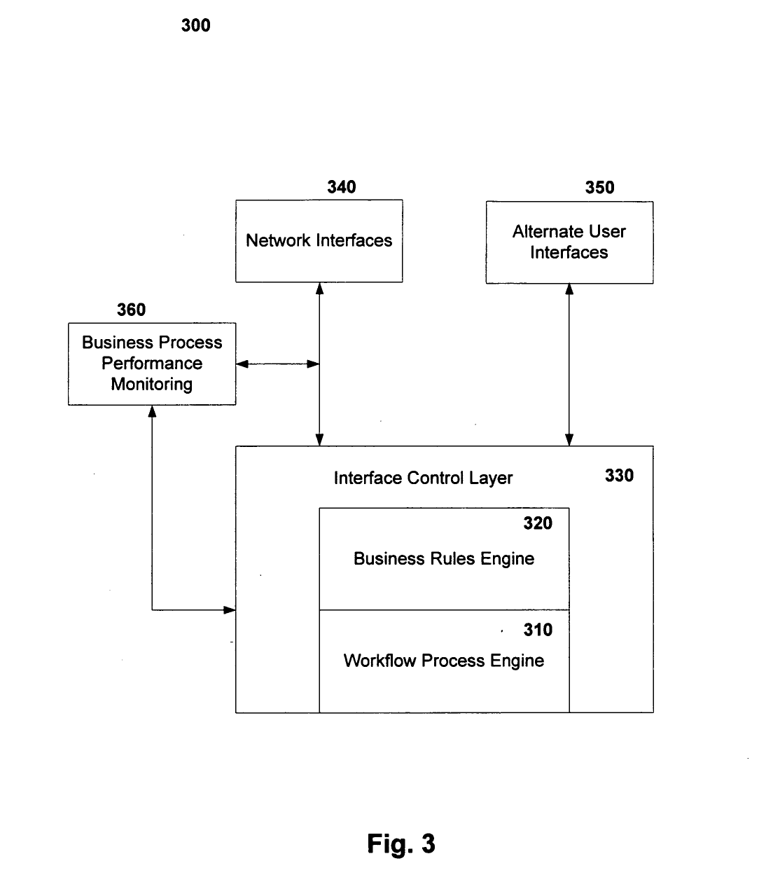

After discussing an exemplary computing environment in conjunction with FIG. 1 in which the invention may be practiced, exemplary embodiments will be discussed in detail in conjunction with FIG. 3.

Exemplary Computing Device

FIG. 1 and the following discussion are intended to provide a brief general description of a suitable computing environment in which the invention may be implemented. It should be understood, however, that handheld, portable and other computing devices and computing objects of all kinds are contemplated for use in connection with the invention. Thus, while a general purpose computer is described below, this is but one example, and the invention may be implemented with other computing devices, such as a client having network/bus interoperability and interaction. Thus, the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation according to the invention.

Although not required, the invention can be implemented via an operating system, for use by a developer of services for a device or object, and/or included within application software that operates according to the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. The invention may also be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer system 110. Components of computer system 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 110 typically includes a variety of computer readable media. Computer readable media can be any available media that can be accessed by computer system 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer system 110, such as during startup, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer system 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer system 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer system 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190, which may in turn communicate with video memory (not shown). In addition to monitor 191, computer systems may also include other peripheral output devices such as speakers 197 and printer 196, which may be connected through an output peripheral interface 195.

The computer system 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer system 110, although only a memory storage device 181 has been illustrated in FIG. 1. The logical connections depicted in FIG. 1 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer system 110 is connected to the LAN 171 through a network interface or adapter 170. When used in a WAN networking environment, the computer system 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer system 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, One Microsoft Way, Redmond, Wash. 98052, includes servers, building-block services, such as Web-based data storage, and downloadable device software. While exemplary embodiments herein are described in connection with software residing on a computing device, one or more portions of the invention may also be implemented via an operating system, application programming interface (API) or a “middle man” object between any of a coprocessor, a display device and a requesting object, such that operation according to the invention may be performed by, supported in or accessed via all of .NET™'s languages and services, and in other distributed computing frameworks as well.

Exemplary Embodiments of the Invention

FIG. 3 depicts a block diagram 300 of one embodiment of the invention. A workflow process engine 310 may create process instances, interpret models of the process, and manage process execution. The workflow processor engine 310 typically routes flows and synchronizes activities, assigns resources to activities, notifies individuals and invokes applications, transmits data and documents to applications and individuals and supports long running business processes and transactions associated with these processes. Workflow or process automation is used to manage complex business processes across organizational boundaries. All of the interfaces of the workflow processor may be available via the interface control layer 330.

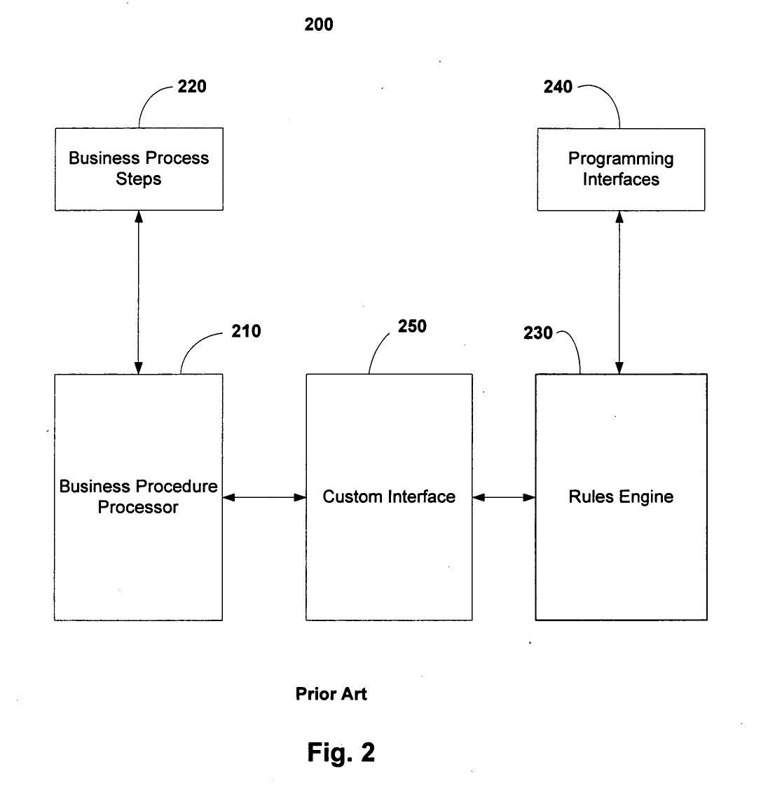

A business rules engine 320 may be used to define, implement, and modify dynamically changing business policies that are applied to the business processes via the workflow processor 310. Workflows traditionally have had problems with smoothly integrating business logic or business rules in the automation of business processes. This has resulted in the traditional approach of having separate workflow processors and business logic or business rules engines. The invention breaks with that tradition and smoothly integrates a workflow processor 310 with a business rules engine 320 such that no custom software need be generated by a user. Instead of having distinct interfaces for programming, process flow, and other input and output functions, an interface control layer 330 is utilized to integrate communications interfaces and provide an integrated user interface with the two combined processor functions of a rules engine 320 and a workflow processor 310. Notably missing from the basic architecture of FIG. 3 is the machine specific prior art custom interface 250 of FIG. 2. The custom interface is not needed in the present invention depicted in FIG. 3 because the workflow processor 310 and a business rules engine 320 functions are highly integrated. In one embodiment, the workflow processor 310 with a business rules engine 320 may be implemented in the same processor.

Exemplary interfaces are preferably a network interface 340 to allow the business rule engine portion to communicate with different departments or external entities which may exist either internally to the enterprise or externally via a standard internet-like connection. The network interface may be any sort of electronic communications interface such as a LAN, WAN, VPN, dedicated point to point network or other similar communications interface allowing access to and from the system. In one embodiment of the invention, a user of the system may utilize the network interfaces to fully access the system, such as from an Internet or Intranet connection. In another embodiment, alternate user interfaces 350 such as dedicated monitors may utilize the system for programming, utilization, or performance monitoring purposes. In another embodiment, a business process performance monitoring interface 360 may be available either via a network interface or via a dedicated interface, for example.

Operationally, the business rules utilized by the business rule engine 320 may be targeted at the business user who can perform policy operations independently of the business process. Such business rules allow an enterprise that may be deploying business processes across organizational boundaries to involve business users in the business process by providing a highly flexible and dynamic framework for applying dynamically changing business polices or rules to the business processes.

One result of the high level of integration of the workflow processor 310 with a business rules engine 320 is that correlation of workflow steps with business rules and the tracking of the progress of a process item in a workflow may now be performed with accuracy. For example, a business document may be the process item that is being circulated through a workflow. At various steps in the workflow, the document may be provided to different entities for different types of handling with respect to programmed business rules. Since the workflow process engine 310 and the business rules engine 320 are closely coupled and since the total orchestration of the flow of the business document is monitored by the interface layer 330, then tracking and correlation information regarding the business document within the process is well known to the system 300. Thus the benefit of accurate tracking and tight correlation between workflow process step and business rule may be achieved. One mechanism of tracking in the system 300 is via the use of a unified tracking framework. This frame work may be used to track the progress of the exemplary business document as it is circulated to the different entities on the network and other interfaces 340, 350.

In one embodiment, a user interface for the business rules engine may be an easy-to-read, declarative way of defining and modifying business policies. This allows a user to insert new or modified business rules by abstracting the business logic from the business process. Therefore, the skill of a programmer need not be required in entering new business rules for use by the workflow processor. The use of easily changeable business rules allows improved organization-wide responses to changes in an operating business environment and reduces the time-to-market and any intervening development cycles. Business rules can be adjusted on a real-time basis without having to change the workflow or orchestration of the automated business process. In one embodiment, dynamic modification without suspension of the orchestration of the business process may be achieved through the use of decision nodes that are implemented as workflow activities or operations parameterized with business rules.

Aspects of the present invention provide the ability to define complex business policies to evaluate conditions involving business object instances and fire appropriate actions via decision nodes in the workflow orchestration. These business policies may encapsulate the business logic of the organization to which it applies. The business objects used in these policies may be any .NET™ objects. An orchestration may use these business policies to inspect the states of elements in the eXtensible Markup Language (XML) documents, (a World Wide Web Consortium®) (W3C) standard), data sets, MSWord™ documents, Excel™ spreadsheets, or in any application that exposes its state via .NET™ objects, and determine the appropriate control logic to be applied. For example, an orchestration can use the business policy or rules engine to perform validations, match patterns, evaluate status, and examine information external to the orchestration to dynamically identify appropriate trading partners during orchestration execution. The criteria used in these decisions can be changed without having to suspend the workflow orchestration.

XML can be used as the primary means to define the business policies and the control logic associated with these policies and an object model that allows tool developers to build and customize the desired tools for their operating environments. With an open implementation standard such as XML, business policies are not in a proprietary format and can be shared across enterprise boundaries.

According to aspects of the invention, a business user can generate and manipulate business policies, rules are expressed in natural language using vocabularies, and/or annotations of business rule elements are provided with friendly display names. The business user does not have to worry or know about the technical details involved with the implementation, and is given a mechanism by which he can change the policy anytime during the lifecycle of the orchestration, and have it propagated immediately through the entire system. The invention may also provide an inference mechanism that allows the result of rule actions to trigger other relevant rules to reflect the change in state of the environment. The execution mechanism of the rules engine may infer that additional rules need to be executed, depending on the state of business objects that are set by previous rule executions.

According to an aspect of the invention, a business rules language (BRL) may be used as an XML based representation to define rules, rulesets (collections of related rules) and vocabularies. The XML representation for rules may provide the common format used to transfer rulesets between organizations as part of the invention.

Preferably, the business rules language may be human-readable to reduce the need for expertly qualified programmers to input rule definitions. The declarative business rules language is preferably a natural translation from business rules as described by business users. The resulting rule language is preferably machine readable and well structured so as to be easily serialized from and de-serialized to a ruleset object model. Rule language definitions are preferably independent from the underlying rule engine algorithm implementation and the language definitions preferably should not specify the runtime semantics of rule engine. Rulesets defined by the business rules language preferably have a unique name for quick human identification. Rules are defined abstractly based on the vocabulary bindings.

A vocabulary of the business rules language may be implemented and may include definitions for terms, predicates and actions used by the rule definitions. An atomic term may be used in the business rules language which may be an XML element, a class property or a table column. A user-defined predicate or action can be a class method, a database query, or a TSQL™ store procedure. Vocabularies may facilitate the integration with .NET™ business objects, XML documents, and other databases. Vocabulary definitions may be based on .NET™ common type system such that the vocabulary may accommodate types from XML Schema, Database Table, and . NET™ classes.

In one embodiment, a business rules language may support vocabulary versioning. A language file may contain multiple versions of vocabularies with the same name and support custom properties for each vocabulary item. Custom properties may be defined as a list of name/value pairs. One utilization of custom properties in a business language vocabulary may be for vocabulary indexing, categorization or partitioning.

A vocabulary may contain vocabulary elements which have name and display name pairs that provide the annotation on any ruleset element. The display name for vocabulary definition enables a customized rule representation for a business user. The display name may also support the expression of rules in non-English languages. A ruleset element may be used to link to any vocabulary element in the same business rules language file. A vocabulary element may also support the custom data that the application or tools may generate.

The following is an example of the business rules language definition of a simple ruleset defining discount policies for a shopping cart. In the example, the rules are defined on two .NET™ C# classes: ShoppingCart and Customer. When the customer checks out, the application fires rules to decide what level of discount to grant based on a customer's category and the purchase amount in the shopping cart.

Example business rules language; user inputs:

```
if
      customer category is “gold” and
      shopping cart subtotal is less than 100 dollars
then
      shopping cart discount is 15%
if
      customer category is “silver” and
      shopping cart subtotal is equal or larger than 100 dollars
then
      shopping cart discount is 15%
      Notify customer
```

The corresponding C# classes for the above example may be expressed as:

```
namespace OnlineShopping
{
    public class Customer
    {
        public String category; // “gold”, “silver”, “bronze”
        public void Notify(String msg) { } // notify customer
    }
    public class ShoppingCart
    {
        private float discount; // 0.10 represent 10% discount
        public float subtotal = 0.0; // set initial value
        // Change the discount
        public void SetDiscount(float d) {discount = d;};
        public Customer customer;
        public float CheckOut( )
        {
            // connect to BRL file
            RuleStore BRL = new RuleStore(“file:///c:/discount.BRL”);
            // load checkout rules
            RuleSet rs = BRL.GetRuleSet(“checkout_policy”);
            // initiate a rule engine instance
            RuleEngine re = new RuleEngine(rs);
            // assert ShoppingCart object into working memory
            re.Assert(this);
            re.Execute( ); // fire the rule execution
            ....
            // caculate the total payment, 0.086 is the salestax
            return (subtotal * discount + subtotal * 0.086);
        }
    }
}
```

The corresponding business rules language representation in XML may be expressed as:

```
<?xml version=“1.0”
    <brl name=“discount_policy” xmlns=“urn:rulelanguage-schema”>
    <ruleset name=“checkout_policy”>
        <version major=“1”/>
        <bindings>
            <class ref=“MyCustomer” class=“Customer”>
                  <assembly>shoppingcart.dll</assembly>
                  <namespace>OnlineShopping</namespace>
            </class>
            <class ref=“MyShoppingCart” class=“ShoppingCart”>
                  <assembly>shoppingcart.dll</assembly>
                  <namespace>OnlineShopping</namespace>
            </class>
        </bindings>
        <rule name=“rule 1”>
            <if>
              <and>
                  <compare operator=“equal”>
                    <lhs>
                        <function>
              <classmember classref=“MyCustomer” member=“category”/>
                        </function>
                    </lhs>
                    <rhs>
                        <constant><string>gold</double></constant>
                    </rhs>
                  </compare>
              <compare operator=“less than”>
                    <lhs>
                        <function>
        <classmember classref=“MyShoppingCart” member=“subtotal”/>
                        </function>
                    </lhs>
                    <rhs>
                        <constant><float>100.00</float></constant>
                    </rhs>
                  </compare>
              </and>
            </if>
            <then>
                  <function>
              <classmember classref=“MyShoppingCart” member=“SetDiscount”>
                  <argument>
                        <constant><float>0.150</float></constant>
                  </argument>
                    </classmember>
                  </function>
            </then>
        </rule>
    ....
    </brl>
```

One aspect of the current invention is that the business rules engine framework allows users to use a data connection object while defining bindings in rules that map to database elements. This feature allows an optimization of data retrieval and evaluation regarding large and disparate databases. A data connection object at runtime essentially may contain multiple database fact sources and the engine optimally may execute the business rules over this data at runtime. An advantage may be achieved by only evaluating the relevant portions of these potentially large data sets, thus providing a potentially significant performance and scalability benefit.

If a simple rule is invoked which has to check, for example, if the date of expiration on an insurance policy has lapsed on any one of 100,000 customers, a large amount of time could be wasted in finding, opening, and examining all of the relevant files of a large dataset. The invention remedies this potential inefficiency by performing an optimized delayed query over the large data set to bring in only the relevant row(s) into the rules engine memory for evaluation and not the entire data-set. The invention may therefore employ a database search engine, such as for example, a SQL database search capability. The delayed query capability may lead to a significant performance improvement over the prior art.

The delayed/optimized query may be implemented by constructing a query statement, such as a SQL query, in the policy that is being executed on the workflow process state. The query is considered delayed because the statement is generated at the last possible moment in the rules runtime to ensure that incoming data is well-known before the query statement is completed. This delayed query construction timing ensures that the query statement is generated for efficient execution, can succeed based on the incoming data, and is optimized to retrieve and search only the relevant data needed so as to reduce the time for query execution and reduce the need for additional secondary queries.

As mentioned above, while exemplary embodiments of the invention have been described in connection with various computing devices and network architectures, the underlying concepts may be applied to any computing device or system in which it is desirable to implement an automated business process. Thus, the methods and systems of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the signal processing capabilities as described in exemplary embodiments above becomes an apparatus for practicing the invention. When implemented on a general purpose processor, the program code combines with the processor to provide a unique apparatus that operates to invoke the functionality of the discussed invention. Additionally, any storage techniques used in connection with the invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms. Therefore, the invention should not be limited to any single embodiment, but rather should be construed in breadth and scope in accordance with the appended claims.

1. A method of tracking operations in an automated business process, the method comprising:
defining a plurality of operations at a plurality of nodes in a business process;
executing a workflow comprising the operations;
applying a plurality of business rules to the workflow at the nodes to affect the operations;
optionally changing the business rules and applying the changed business rules during execution of the workflow; and
providing a correlation between the business rules applied to the nodes and the corresponding affected operations to track operations within the workflow.

2. The method of claim 1, wherein executing a workflow comprises executing a pre-defined progression of operations, wherein the operations are at least one of transactions internal to a business enterprise and transactions external to a business enterprise.

3. The method of claim 1, wherein the operations comprise passing XML formatted messages according to the workflow.

4. The method of claim 1, wherein applying a plurality of business rules to the workflow comprises using a rules engine integrated with a workflow processor.

5. The method of claim 1, wherein optionally changing the business rules and applying the changed business rules during execution of the workflow comprises implementing a changed business rule while avoiding at least one of suspending, recompiling and redeploying the workflow.

6. The method of claim 1, wherein optionally changing the business rules and applying the changed business rules during execution of the workflow comprises utilizing at least one declarative if/then statement.

7. The method of claim 1, wherein providing a correlation between the business rules applied to the nodes and corresponding affected operations comprises providing a correspondence between a specific business rule executed at a node and a resultant state of an operation within the workflow of the automated business process.

8. A computer system comprising;
a first processor function for executing instructions corresponding to a business workflow;
a second processor function for executing instructions corresponding to a plurality of business rules;
a first input device for receiving a document for routing according to the business workflow;
a second input device for accepting a change made to at least one of the business rules; and
an output device for transmitting the document according to the business workflow;
wherein upon an input from the first input device, the document is processed according to the business workflow using the business rules, and upon an input from the second input device, a workflow process affecting the document is changed in accordance with the change made to the at least one of the business rules, and wherein the workflow process is uninterrupted as a result of applying the change made to the at least one of the business rules.

9. The computer system of claim 8, wherein the first processor function and the second processor function comprise the same processing unit.

10. The computer system of claim 9, wherein the first processor function and the second processor function share information such that each individual business rule applied to a workflow step may be at least one of tracked, logged, inspected and correlated.

11. The computer system of claim 8, wherein the first input device comprises an interface to a computer network.

12. The computer system of claim 8, wherein the second input device comprises a computer terminal.

13. The computer system of claim 8, wherein the output device comprises an interface to a computer network.

14. The computer system of claim 8, further comprising a query engine wherein a query is constructed to evaluate at least one of the business rules.

15. The computer system of claim 14, wherein construction of the query is delayed in the workflow process such that the query is executed over a data set smaller than a full sized data set whereby a time-efficient query results.

16. A machine-readable medium, comprising instructions which execute a method of tracking of operations in an automated business process, the method comprising:
defining a plurality of operations at a plurality of nodes in a business process;
executing a workflow comprising the operations;
applying a plurality of business rules to the workflow at the nodes to affect the operations;
optionally changing the business rules and applying the changed business rules during execution of the workflow; and
providing a correlation between the business rules applied to the nodes and the corresponding affected operations to provide tracking of operations within the workflow.

17. The machine-readable medium of claim 16, wherein the operations comprise passing XML formatted messages according to the workflow.

18. The machine-readable medium of claim 16, wherein applying plurality of business rules to the workflow comprises using a rules engine integrated with a workflow processor.

19. The machine readable medium of claim 16, wherein optionally changing the plurality of business rules and applying the changed business rules during execution of the workflow comprises implementing a changed business rule while avoiding at least one of suspending, recompiling and redeploying the workflow.

20. The machine-readable medium of claim 16, wherein providing a correlation between the business rules applied to the nodes and corresponding affected operations comprises providing a correspondence between a specific business rule executed at a node and a resultant state of an operation within the workflow of the automated business process.

21. A method of business process automation, the method comprising:
executing a business process workflow in a machine comprising a workflow processor and a rules engine, wherein the business process workflow derives decision criteria from at least one rule, and wherein the workflow processor and rules engine comprise the same machine;
utilizing rule changes while simultaneously continuing execution of the workflow, wherein the changes comprise declarative if/then statements; and
optionally utilizing at least one database query to acquire information relevant to the workflow process and the at least one rule.

22. The method of claim 21, further comprising providing a correlation between the at least one rule and a corresponding operation of the workflow process wherein the state of the operation is defined by an application of the at least one rule.

23. The method of claim 21, wherein the at least one database query is delayed in the business process workflow such that the query is executed over a data set smaller than a full sized data set in the database whereby a time-efficient query results.
